(19) United States
(12) Patent Application Publication
(10) Pub. No.: US 2025/0020813 A1
(43) Pub. Date: Jan. 16, 2025

(54) INFORMATION PROCESSING METHOD, PROGRAM, POSITION MEASUREMENT APPARATUS, AND POSITION MEASUREMENT SYSTEM

(71) Applicant: SONY GROUP CORPORATION, TOKYO (JP)

(72) Inventors: KATSUNORI HONMA, TOKYO (JP); HIROTAKA TANAKA, TOKYO (JP); SATOSHI SUZUKI, TOKYO (JP)

(21) Appl. No.: 18/711,922

(22) PCT Filed: Oct. 19, 2022
(86) PCT No.: PCT/JP2022/038908

§ 371 Date: May 21, 2024

(30) Foreign Application Priority Data
Nov. 30, 2021 (JP) 2021-194614

(51) Int. Cl. G01S 19/39; G01S 19/51

(52) U.S. Cl. CPC G01S 19/396; G01S 19/51

(57) ABSTRACT

[Object] To provide a technology that also enables a target to acquire global positional coordinates of the target when the target fails to obtain the global positional coordinates by itself. [Solving Means] An information processing method according to the present technology includes calculating, by a position measurement apparatus, global positional coordinates of the position measurement apparatus; observing, by the position measurement apparatus, a target to calculate a relative position of the position measurement apparatus relative to the target; and calculating, by the position measurement apparatus, first global positional coordinates of the target on the basis of the global positional coordinates of the position measurement apparatus and the relative position.

### TECHNICAL FIELD

The present technology relates to a technology used for, for example, an information processing method performed to obtain global positional coordinates of a target.

### BACKGROUND ΔRT

In general, drones receive global positioning system (GPS) signals from pluralities of GPS satellites to obtain global positional coordinates of the respective drones. On the other hand, there is a possibility that drones will fail to receive GPS signals at some locations such as indoors, underground, and in the window of a building.

If a drone fails to receive a GPS signal upon start of the drone, the drone will fail to acquire global positional coordinates and to recognize where the drone is situated on the earth. Further, if a drone fails to receive a GPS signal during its flight, the drone may lose track of global positional coordinates.

Currently, a large number of drones are restricted in their start of flight or their flight at locations at which GPS signals fail to be received.

Note that Patent Literatures 1 and 2 indicated below disclose technologies related to the GPS.

### CITATION LIST

### Patent Literature

Patent Literature 1: Japanese Patent Application Laid-open No. 2001-309418
Patent Literature 2: Japanese Patent Application Laid-open No. 2014-002103

### DISCLOSURE OF INVENTION

### Technical Problem

There is a need for a technology that also enables a target such as a drone to acquire global positional coordinates of the drone when the target fails to obtain the global positional coordinates by itself due to, for example, failing to receive a GPS signal.

In view of the circumstances described above, it is an object of the present technology to provide a technology that also enables a target to acquire global positional coordinates of the target when the target fails to obtain the global positional coordinates by itself.

### Solution to Problem

An information processing method according to the present technology includes calculating, by a position measurement apparatus, global positional coordinates of the position measurement apparatus; observing, by the position measurement apparatus, a target to calculate a relative position of the position measurement apparatus relative to the target; and calculating, by the position measurement apparatus, first global positional coordinates of the target on the basis of the global positional coordinates of the position measurement apparatus and the relative position.

In the present technology, the position measurement apparatus calculates global positional coordinates of the target. Thus, the target can acquire global positional coordinates of the target even when the target fails to obtain the global positional coordinates by itself.

A program according to the present technology causes a position measurement apparatus to perform a process including calculating global positional coordinates of the position measurement apparatus; observing a target to calculate a relative position of the position measurement apparatus relative to the target; and calculating first global positional coordinates of the target on the basis of the global positional coordinates of the position measurement apparatus and the relative position.

A position measurement apparatus according to the present technology includes a controller that calculates global positional coordinates of the position measurement apparatus, observes a target to calculate a relative position of the position measurement apparatus relative to the target, and calculates first global positional coordinates of the target on the basis of the global positional coordinates of the position measurement apparatus and the relative position.

A position measurement system according to the present technology includes a position measurement apparatus and a target. The position measurement apparatus includes a controller that calculates global positional coordinates of the position measurement apparatus, observes the target to calculate a relative position of the position measurement apparatus relative to the target, and calculates first global positional coordinates of the target on the basis of the global positional coordinates of the position measurement apparatus and the relative position.

### BRIEF DESCRIPTION OF DRAWINGS

FIG. 1 illustrates a position measurement system according to a first embodiment.

FIG. 2 is a block diagram illustrating an internal configuration of a smartphone.

FIG. 3 illustrates other examples of a position measurement apparatus.

FIG. 4 is a block diagram illustrating an internal configuration of a drone.

FIG. 5 is a flowchart of processing performed by the smartphone and processing performed by the drone.

FIG. 6 is a supplemental diagram used to describe the processing performed by the smartphone and the processing performed by the drone.

FIG. 7 is a supplemental diagram used to describe the processing performed by the smartphone and the processing performed by the drone.

FIG. 8 is a supplemental diagram used to describe the processing performed by the smartphone and the processing performed by the drone.

FIG. 9 is a block diagram illustrating an internal configuration of a drone according to a second embodiment.

FIG. 10 is a flowchart of processing performed by the smartphone according to the second embodiment and processing performed by the drone according to the second embodiment.

FIG. 11 illustrates effective distances used to measure a relative position using a depth sensor for different kinds of the position measurement apparatus.

FIG. 12 illustrates a position measurement system according to a third embodiment.

FIG. 13 illustrates a position observation system according to a fourth embodiment.

### MODE(S) FOR CARRYING OUT THE INVENTION

Embodiments according to the present technology will now be described below with reference to the drawings.

### First Embodiment

### Overall Configuration and Configuration of Each Structural Element

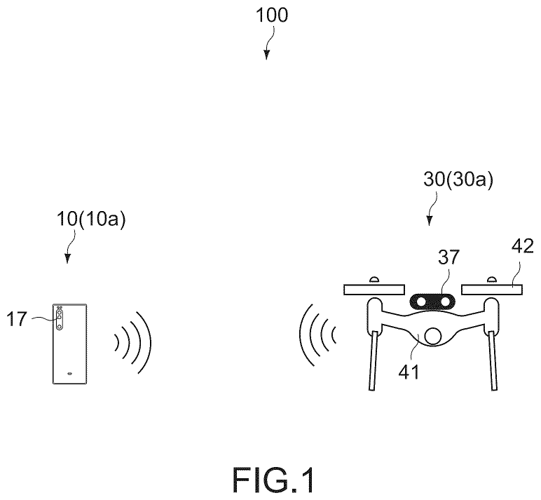

FIG. 1 illustrates a position measurement system 100 according to a first embodiment of the present technology. As illustrated in FIG. 1, the position measurement system 100 includes a smartphone 10a (a position measurement apparatus 10) and a drone 30a (a target 30).

[Smartphone 10a]

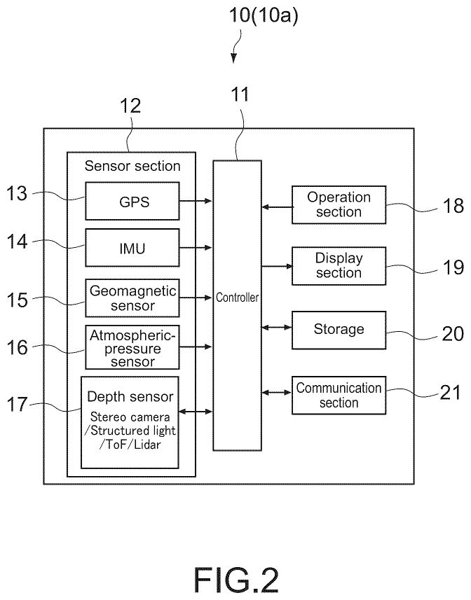

FIG. 2 is a block diagram illustrating an internal configuration of the smartphone 10a. As illustrated in FIG. 2, the smartphone 10a includes a controller 11, a sensor section 12, an operation section 18, a display section 19, a storage 20, and a communication section 21. The sensor section 12 includes a GPS 13, an inertial measurement unit (IMU) 14, a geomagnetic sensor 15, an atmospheric-pressure sensor 16, and a depth sensor 17.

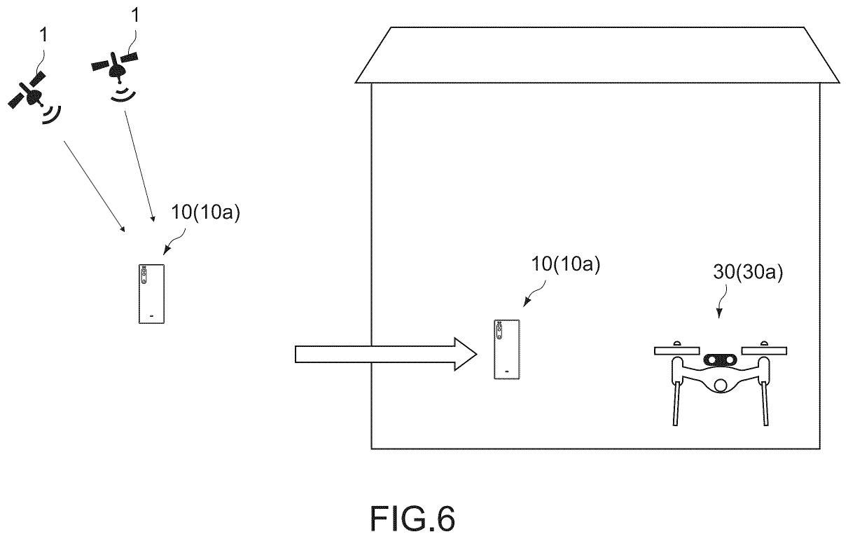

The GPS 13 generates global positional coordinates of the smartphone 10a on the basis of GPS signals from a plurality of GPS satellites 1 (refer to, for example, FIG. 6 described later), and outputs the global positional coordinates to the controller 11.

The IMU 14 includes an acceleration sensor that detects acceleration along three axes that are orthogonal to each other, and an angular velocity sensor that detects angular velocity around three axes that are orthogonal to each other. The IMU 14 outputs information regarding the detected acceleration and information regarding the detected angular velocity to the controller 11.

The geomagnetic sensor 15 detects geomagnetism, and outputs information regarding the geomagnetism (information regarding orientation) to the controller 11. The atmospheric-pressure sensor 33 measures atmospheric pressure, and outputs information regarding the atmospheric pressure (information regarding height) to the controller 11.

The depth sensor 17 can measure a distance to an object situated in surroundings of the smartphone 10a using an approach such as a stereo camera, structured light, time of flight (ToF), or light detection and ranging (Lidar). The depth sensor 17 acquires information regarding a depth from the smartphone 10a to an object situated in the surroundings of the smartphone 10a, in order to generate an environment map of the surroundings of the smartphone 10a and to measure a relative position of the smartphone 10a relative to the drone 30a.

The operation section 18 includes, for example, a pressing button and a touch sensor provided on the display section 19. The operation section 18 detects various operations input by a user, and outputs the detected operations to the controller 11. The display section 19 includes, for example, a liquid crystal display or an organic electroluminescence (EL) display, and causes various images to be displayed on a screen under the control of the controller 11.

The storage 20 includes a nonvolatile memory and a volatile memory. The nonvolatile memory stores thereon various programs necessary for the controller 11 to perform processing, and various data. The volatile memory is used as a working region for the controller 11.

Note that the various programs described above may be read from a portable recording medium such as an optical disk or a semiconductor memory, or may be downloaded from a server apparatus in a network.

The communication section 21 is configured such that the smartphone 10a and the drone 30a can perform near field communication with each other using, for example, a wireless LAN (wireless fidelity (Wi-Fi)), Bluetooth (BT), or optical communication; or can communicate with each other by wire using Ethernet or a universal serial bus (USB). Further, the communication section 21 is configured such that the smartphone 10a including the communication section 21 can communicate with, for example, another smartphone 10a or a server apparatus in a network through a base station.

The controller 11 performs various calculations on the basis of various programs stored in the storage 20, and comprehensively controls each structural element of the drone 30a.

The controller 11 is implemented by hardware or a combination of hardware and software. The hardware is a portion of or all of the controller 11, and examples of the hardware include a central processing unit (CPU), a graphics processing unit (GPU), a vision processing unit (VPU), a digital signal processor (DSP), a field programmable gate array (FPGA), an application specific integrated circuit (ASIC), or a combination of at least two thereof. Note that the same applies to a controller 31 of the drone 30a.

In the present embodiment, for example, the controller 11 of the smartphone 10a sets global positional coordinates of the smartphone 10a itself on the basis of a GPS signal, and estimates a self-position of the smartphone 10a on the basis of simultaneous localization and mapping (SLAM). Further, for example, the controller 11 calculates a relative position of the smartphone 10a relative to the drone 30a, calculates global positional coordinates of the drone 30a on the basis of the global positional coordinates of the smartphone 10a and the relative position, and transmits the global positional coordinates of the drone 30a to the drone 30a. Processing performed by the controller 11 of the smartphone 10a will be described in detail later.

Note that the present embodiment is described using SLAM processing as an example of self-position estimating processing. However, the self-position estimating processing may be performed using a method other than SLAM. Typically, this self-position estimating processing may be any self-position estimating processing performed on the basis of relative changes in own position and pose that are caused for a specified period of time (self-position estimating processing performed on the basis of relative changes in position and pose, not on the basis of absolute global positional coordinates obtained using, for example, GPS).

Here, the smartphone 10a is an example of the position measurement apparatus 10. Typically, the position measurement apparatus 10 may be any apparatus that can acquire global positional coordinates of the apparatus, can calculate a relative position of the apparatus relative to the target 30 (the drone 30a), and can calculate global positional coordinates of the target 30 on the basis of the global positional coordinates of the apparatus and the relative position (and can estimate a self-position using, for example, SLAM).

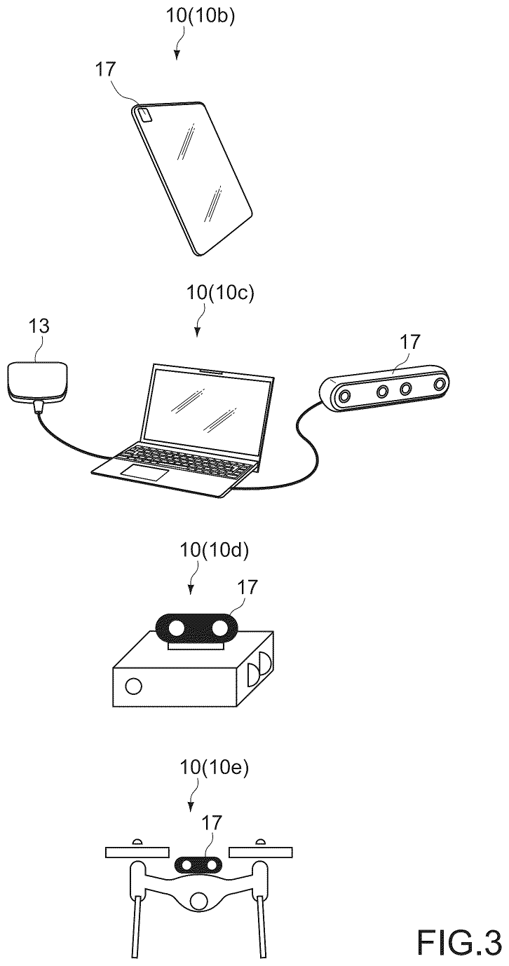

FIG. 3 illustrates other examples of the position measurement apparatus 10. FIG. 3 illustrates, from the top to the bottom, an example in which the position measurement apparatus 10 is a tablet personal computer (PC) 10b, an example in which the position measurement apparatus 10 is a laptop 10b, an example in which the position measurement apparatus 10 is a dedicated device 10d, and an example in which the position measurement apparatus 10 is a drone 10e.

When the position measurement apparatus 10 is the tablet PC 10b, the tablet PC 10b has a configuration similar to the configuration of the smartphone 10a in principle. Note that, today, the smartphone 10a and tablet PC 10b each including the depth sensor 17 (such as Lidar, Tof, or a stereo camera) are becoming prevalent.

When the position measurement apparatus 10 is the laptop 10b and when the GPS 13 or the depth sensor 17 is not included in the laptop 10b, the GPS 13 or the depth sensor 17 is added to the laptop 10b.

When the position measurement apparatus 10 is the dedicated device 10d, this makes it possible to achieve a higher performance of the depth sensor 17, compared to the cases of general-purpose apparatuses such as the smartphone 10a, the tablet PC 10b, and the laptop 10b. Further, this also makes it possible to more efficiently perform self-position estimating processing using, for example, SLAM.

When the position measurement apparatus 10 is the drone 30a, the drone 30a typically includes, for example, the depth sensor 17 to perform self-position estimating processing using, for example, SLAM. Note that the position measurement apparatus 10 may be a robot, such as a vehicle robot, that is other than the drone 30a.

[Drone 30a]

Referring to FIG. 1 again, the drone 30a includes a drone body 41 and a depth sensor 37 that is provided to the drone body 41.

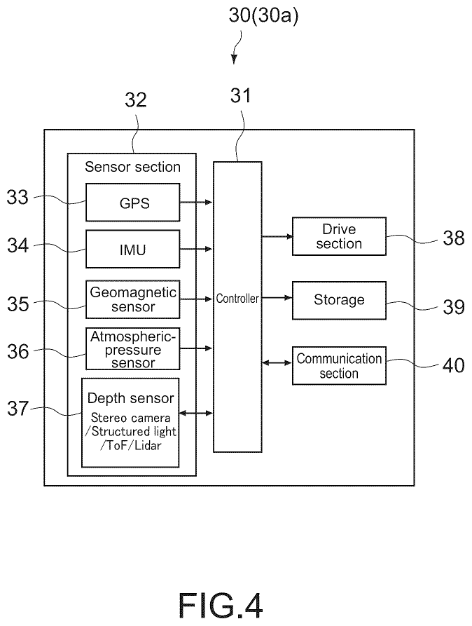

FIG. 4 is a block diagram illustrating an internal configuration of the drone 30a. As illustrated in FIG. 4, the drone 30a includes a sensor section 32, a drive section 38, a storage 39, and a communication section 40. The sensor section 32 includes a GPS 33, an IMU 34, a geomagnetic sensor 35, an atmospheric-pressure sensor 36, and the depth sensor 37.

The GPS 33 generates global positional coordinates of the drone 30a on the basis of GPS signals from a plurality of GPS satellites 1, and outputs the global positional coordinates to the controller 31.

The IMU 34 includes an acceleration sensor that detects acceleration along three axes that are orthogonal to each other, and an angular velocity sensor that detects angular velocity around three axes that are orthogonal to each other. The IMU 34 outputs information regarding the detected acceleration and information regarding the detected angular velocity to the controller 31.

The geomagnetic sensor 35 detects geomagnetism, and outputs information regarding the geomagnetism (information regarding orientation) to the controller 31. The atmospheric-pressure sensor 36 measures atmospheric pressure, and outputs information regarding the atmospheric pressure (information regarding height) to the controller 31.

The depth sensor 37 can measure a distance to an object situated in surroundings of the drone 30a using an approach such as a stereo camera, structured light, ToF, or Lidar. The depth sensor 37 acquires information regarding a depth from the drone 30a to an object situated in the surroundings of the drone 30a, in order to generate an environment map of the surroundings of the drone 30a.

The drive section 38 is, for example, a motor to which a rotor 42 is attached, and drives the rotor 42 under the control of the controller 11.

The storage 39 includes a nonvolatile memory and a volatile memory. The nonvolatile memory stores thereon various programs necessary for the controller 31 to perform processing, and various data. The volatile memory is used as a working region for the controller 31.

Note that the various programs described above may be read from a portable recording medium such as an optical disk or a semiconductor memory, or may be downloaded from a server apparatus in a network.

The communication section 40 is configured such that the drone 30a and the smartphone 10a can communicate with each other wirelessly or by wire. Further, the communication section 40 is configured such that the drone 30a can communicate with, for example, a server apparatus in a network as necessary.

The controller 31 performs various calculations on the basis of various programs stored in the storage 39, and comprehensively controls each structural element of the drone 30a.

In the present embodiment, for example, the controller 31 of the drone 30a sets global positional coordinates of the drone 30a that are transmitted by the smartphone 10a, and estimates a self-position of the drone 30a on the basis of SLAM. Processing performed by the controller 31 of the drone 30a will be described in detail later.

Note that the drone 30a does not necessarily have to include a SLAM function. In this case, sensors, such as the IMU 14 and the depth sensor 17, that are used for the SLAM function may be omitted. A configuration of the drone 30a not including the SLAM function will be described in a second embodiment.

Operations of, for example, inputting flight commands and flight paths to the drone 30a are performed using, for example, a dedicated controller (not illustrated). Note that the smartphone 10a may include a function of the dedicated controller.

Here, the drone 30a is an example of the target 30 to be observed by the position measurement apparatus 10. Typically, the target 30 is an apparatus for which global positional coordinates of the target 30 are necessary, and the target 30 may be any apparatus that can acquire global positional coordinates of the apparatus from the position measurement apparatus 10 using communication.

For example, the target 30 may be various robots such as a robot cleaner and a vehicle robot, or may be a cellular phone (including a smartphone), the tablet PC 10b, or a vehicle.

### Description of Operation

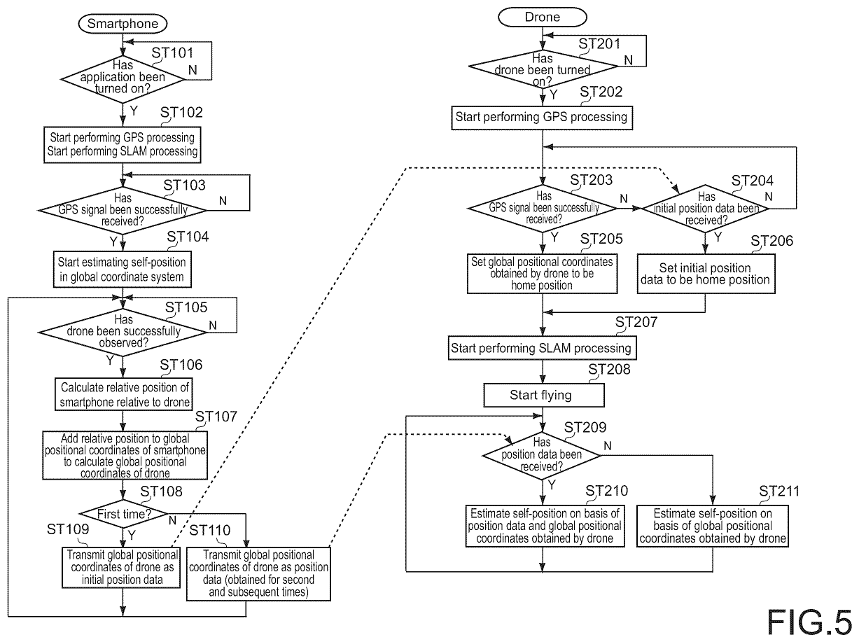

Next, processing performed by the smartphone 10a and processing performed by the drone 30a are described. FIG. 5 is a flowchart of the processing performed by the smartphone 10a and the processing performed by the drone 30a. FIGS. 6, 7 and 8 are supplemental diagrams used to describe the processing performed by the smartphone 10a and the processing performed by the drone 30a.

[Processing Performed by Smartphone 10a]

First, processing performed by the controller 11 of the smartphone 10a is described. First, the controller 11 of the smartphone 10a determines whether an application based on the program has been turned on (Step 101).

When it has been determined that the application has been turned on (YES in Step 101), the controller 11 of the smartphone 10a starts performing GPS processing on the basis of a GPS signal, and starts acquiring global positional coordinates of the smartphone 10a (Step 102). Further, at this point, the controller 11 of the smartphone 10a starts operating each sensor included in the sensor section 12 of the smartphone 10a, and starts performing self-position estimating processing on the basis of SLAM (Step 102).

In the self-position estimating processing performed on the basis of SLAM, the controller 11 of the smartphone 10a calculates amounts of relative changes in a position and a pose of the smartphone 10a for each specified period of time, and adds the amounts of the changes to a previous position and a previous pose of the smartphone 10a to calculate a current position and a current pose of the smartphone 10a.

In the self-position estimating processing performed on the basis of SLAM, the controller 11 of the smartphone 10a typically performs processing indicated below (the same applies to the drone 30a). First, the controller 11 of the smartphone 10a generates an environment map of the surroundings of the smartphone 10a on the basis of depth information from the depth sensor 17. Further, the controller 11 of the smartphone 10a compares a feature point included in the environment map with a feature point acquired by the depth sensor 17 at a current viewing angle, and calculates amounts of changes in a current position and a current pose of the smartphone 10a.

Further, the controller 11 of the smartphone 10a calculates the amounts of the changes in the current position and the current pose of the smartphone 10a on the basis of acceleration information and angular velocity information from the IMU 14, geomagnetism information (information regarding orientation) from the geomagnetic sensor 15, and atmospheric-pressure information (information regarding height) from the atmospheric-pressure sensor 16. The obtained amounts of the changes are integrated using, for example, an extended Kalman filter to obtain final amounts of changes in the position and the pose of the smartphone 10a. Then, the obtained final amounts of the changes are added to the previous position and the previous pose of the smartphone 10a as the amounts of the changes in the current position and the current pose of the smartphone 10a.

After the controller 11 of the smartphone 10a starts performing the GPS processing and the SLAM processing, the controller 11 of the smartphone 10a then determines whether a GPS signal has been successfully received (Step 103).

When it has been determined that the GPS signal has not been successfully received yet (NO in Step 103), the controller 11 of the smartphone 10a returns to Step 103. Note that, when the GPS signal has not been successfully received yet, the controller 11 of the smartphone 10a has not successfully recognized global positional coordinates. Thus, the self-position estimating processing corresponds to self-position estimation locally performed on the basis of SLAM.

On the other hand, when it has been determined that the GPS signal has been successfully received (YES in Step 103), the controller 11 of the smartphone 10a moves on to the next process of Step 104. Note that, as illustrated in FIG. 6, a user holds the smartphone 10a, moves to a location such as outdoors where the GPS signal is received, and causes the smartphone 10a to acquire the GPS signal at least once.

In Step 104, the controller 11 of the smartphone 10a starts performing the processing of estimating a self-position in a global positional coordinate system on the basis of global positional coordinates from the GPS 13.

Here, FIG. 6 illustrates an example in which the smartphone 10a is held by the user to be moved from outdoors to indoors and this results in a GPS signal not being received. On the other hand, when the controller 11 of the smartphone 10a successfully acquires global positional coordinates of the smartphone 10a itself from the GPS 13 at least once, the controller 11 of the smartphone 10a can estimate the position and the pose of the smartphone 10a in the global coordinate system by only performing the self-position estimating processing on the basis of SLAM.

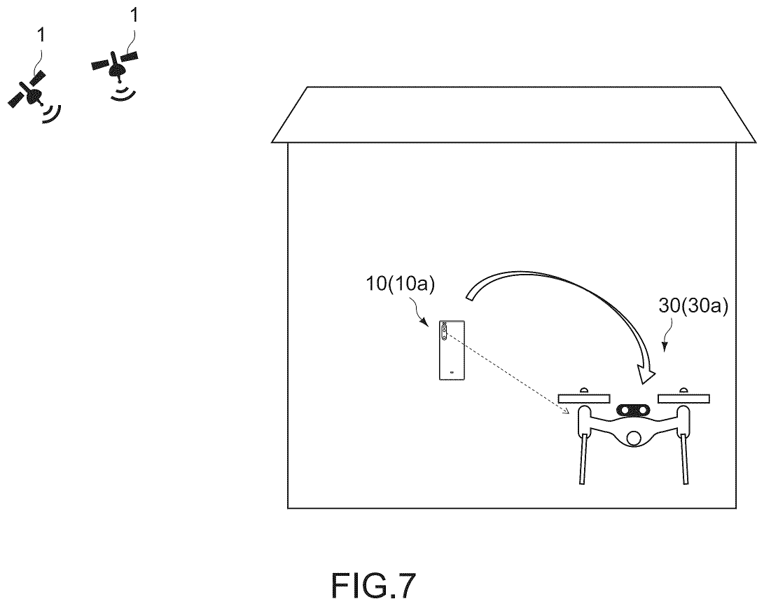

After the controller 11 of the smartphone 10a starts performing the processing of estimating a self-position in the global coordinate system, the controller 11 of the smartphone 10a then determines whether the drone 30a has been successfully observed using the depth sensor 17 (Step 105). For example, the user turns the depth sensor 17 (for example, a stereo camera) to the drone 30a so that the drone 30a is observed using the depth sensor 17, as illustrated in FIG. 7.

When it has been determined that the drone 30a has been successfully observed (YES in Step 105), the controller 11 of the smartphone 10a calculates a relative position of the smartphone 10a relative to the drone 30a on the basis of information regarding depth acquired by the depth sensor 17 (Step 106).

Next, the controller 11 of the smartphone 10a adds the relative position to the global positional coordinates of the smartphone 10a (itself) to calculate global positional coordinates (first global positional coordinates) of the drone 30a (Step 107).

Next, the controller 11 of the smartphone 10a determines whether the global positional coordinates of the drone 30a have been calculated for the first time (Step 108). When it has been determined that the global positional coordinates of the drone 30a have been calculated for the first time (YES in Step 108), the controller 11 of the smartphone 10a transmits the global positional coordinates of the drone 30a to the drone 30a as data of an initial position of the drone 30a (Step 109).

FIG. 7 illustrates an example in which the global positional coordinates of the drone 30a are transmitted to the drone 30a as data of an initial position of the drone 30a.

When it has been determined, in Step 108, that the global positional coordinates of the drone 30a have been calculated for the second and subsequent times (NO in Step 108), the controller 11 of the smartphone 10a transmits those global positional coordinates of the drone 30a to the drone 30a as position data obtained for the second and subsequent times (Step 110).

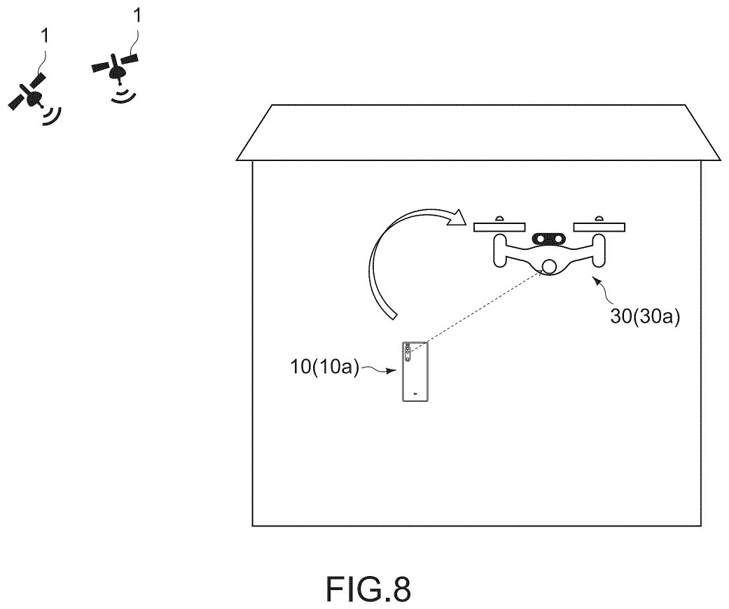

Note that, after the drone 30a acquires the initial position data and the drone 30a starts flying, the user turns the depth sensor 17 to the drone 30a in flight so that the drone 30a is observed using the depth sensor 17, as illustrated in FIG. 8 (YES in Step 105: for the second and subsequent times). Consequently, position data obtained for the second and subsequent times is transmitted from the drone 30a to the drone 30a.

[Processing Performed by Drone 30a]

Next, processing performed by the controller 31 of the drone 30a is described. First, the controller 31 of the drone 30a determines whether the drone 30a has been turned on (Step 201). When it has been determined that the drone 30a has been turned on (YES in Step 201), the controller 31 of the drone 30a starts performing GPS processing, and starts acquiring global positional coordinates of the drone 30a (Step 202).

Next, the controller 31 of the drone 30a determines whether a GPS signal has been successfully received (Step 203). When it has been determined that the drone 30a has successfully received the GPS signal by itself and successfully acquired the global positional coordinates of the drone 30a from the GPS 33 (YES in Step 203), the controller 31 of the drone 30a moves on to Step 205.

In Step 205, the controller 31 of the drone 30a sets the global positional coordinates obtained by the drone 30a to be a home position in the global coordinate system (Step 205).

On the other hand, when it has been determined that the drone 30a has not successfully received the GPS signal by itself (NO in Step 203), the controller 31 of the drone 30a moves on to Step 204. In Step 204, the controller 31 of the drone 30a determines whether initial position data from the smartphone 10a, that is, global positional coordinates of the drone 30a that are obtained by the smartphone 10a have been received (Step 204).

When it has been determined that the initial position data has not been received from the smartphone 10a (NO in Step 204), the controller 31 of the drone 30a returns to Step 203, and determines again whether the drone 30a has received the GPS signal by itself.

When it has been determined, in Step 204, that the initial position data has been received from the smartphone 10a (YES in Step 204), the controller 31 of the drone 30a sets the initial position data from the smartphone 10a to be the home position in the global coordinate system (Step 206).

Here, FIG. 7 illustrates an example in which the drone 30a fail to acquire, from a GPS signal, global positional coordinates of the drone 30a by itself but successfully acquires the global positional coordinates of the drone 30a by acquiring initial position data from the smartphone 10a.

In Step 205, the controller 31 of the drone 30a sets, to be the home position, the global positional coordinates of the drone 30a, which are obtained by the drone 30a itself, or in Step 206, the controller 31 of the drone 30a sets, to be the home position, the global positional coordinates of the drone 30a (the initial position data), which are obtained by the smartphone 10a. Thereafter, the controller 31 of the drone 30a moves on to the next process of Step 207.

In Step 207, the controller 31 of the drone 30a starts operating each sensor included in the sensor section 32 of the drone 30a, and starts performing self-position estimating processing on the basis of SLAM.

In the self-position estimating processing performed on the basis of SLAM, the controller 31 of the drone 30a calculates amounts of relative changes in a position and a pose of the drone 30a for each specified period of time, and adds the amounts of the changes to a previous position and a previous pose of the drone 30a to calculate a current position and a current pose of the drone 30a.

Note that the global positional coordinates of the drone 30a have been already acquired in Step 207. This enables the controller 31 of the drone 30a to estimate a position and a pose of the drone 30a in the global coordinate system by performing the self-position estimating processing on the basis of SLAM.

After the controller 31 of the drone 30a starts performing the self-position estimating processing on the basis of SLAM, the controller 31 of the drone 30a then controls the drive section 38 to start flying the drone 30a (Step 208).

Here, currently, it is often the case that the drone 30a is restricted in its start of flight or its flight when global positional coordinates are not successfully acquired by the drone 30a due to the drone 30a being situated, for example, indoors. On the other hand, in the present embodiment, global positional coordinates of the drone 30a will be notified by the smartphone 10a to the drone 30a even if the drone 30a fails to obtain the global positional coordinates by itself. This makes it possible to start flying or fly the drone 30a even at a location at which the drone 30a fails to receive a GPS signal.

After the controller 31 of the drone 30a starts flying the drone 30a, the controller 31 of the drone 30a determines whether position data obtained for the second and subsequent times has been received from the smartphone 10a (Step 209).

When it has been determined that the position data obtained for the second and subsequent times has been received (YES in Step 209), the controller 31 of the drone 30a moves on to Step 210. In Step 210, the controller 31 of the drone 30a estimates a self-position in the global coordinate system on the basis of the position data (the first global positional coordinates) received from the smartphone 10a, and on the basis of the global positional coordinates (second global positional coordinates) based on the GPS processing and SLAM processing being performed by the drone 30a.

On the other hand, when it has been determined, in Step 209, that the position data obtained for the second and subsequent times has not been received (NO in Step 209), the controller 31 of the drone 30a performs the self-position estimating processing on the basis of the global positional coordinates based on the GPS processing and SLAM processing being performed by the controller 31 (based only on the SLAM processing when the GPS signal is not successfully received) (Step 211).

### “Weighting Based on Degree of Reliability”

Step 210 is described in detail. In the description made here, global positional coordinates (position data) of the drone 30a that are received by the drone 30a from the smartphone 10a are referred to as the first global positional coordinates. On the other hand, global positional coordinates that are obtained by the drone 30a on the basis of GPS processing (and SLAM processing) that is performed by the drone 30a itself are referred to as the second global positional coordinates.

In Step 210, the controller 31 of the drone 30a typically determines a degree of reliability, that is, which of the first global positional coordinates received from the smartphone 10a and the second global positional coordinates calculated by the drone 30a are reliable to what extent. Then, the controller 31 of the drone 30a weights the first global positional coordinates and the second global positional coordinates on the basis of the degrees of reliability to calculate final global positional coordinates of the drone 30a.

Here, examples of the global positional coordinates of the smartphone 10a and the drone 30a include five pieces of information indicated below.
1. SA: Global positional coordinates of the smartphone 10a that are obtained when the smartphone 10a successfully receives a GPS signal directly.
2. SB (=SA+ΔSB): Global positional coordinates of the smartphone 10a that are obtained by adding a relative movement position ΔSB obtained using SLAM processing to the latest global positional coordinates SA based on a GPS signal when the smartphone 10a fails to receive the GPS signal after the smartphone 10a receives the GPS signal directly and obtains SA.
3. SC (=SA+ΔSC or SB+ΔSC): Global positional coordinates (the first global positional coordinates) of the drone 30a that are obtained by the smartphone 10a adding, to global positional coordinates (SA or SB) of the smartphone 10a, a relative position ΔSC of the smartphone 10a relative to the drone 30a
4. DA: Global positional coordinates of the drone 30a that are obtained when the drone 30a successfully receives a GPS signal directly.
5. DB (=DA+ΔDB): Global positional coordinates (the second global positional coordinates) of the drone 30a that are obtained by adding a relative movement position ΔDB obtained using SLAM processing to the latest global positional coordinates DA based on a GPS signal when the drone 30a fails to receive the GPS signal after the drone 30a receives the GPS signal directly and obtains DA

### (1) Stability in GPS Signal Received by Drone 30a

When the drone 30a receives a GPS signal stably and when the drone 30a obtains DA stably, DA is more reliable than SC, and is given priority over SC. Thus, final global positional coordinates CO of the drone 30a that are to be adopted are obtained using the following formula: CO=w1×DA+w2×SC. A relationship between weight values w1 and w2 is “w1>w2”. Note that “w1=1 and w2=0” may be acceptable, and, in this case, “CO=DA”. Note that, with respect to the fact that one of the two weight values may be set to one and another of the two weight values may be set to zero, the same applies to w3 to w10, which will be described later.

(2) GPS performance of Each of Smartphone 10a and Drone 30a

With respect to the global positional coordinates SC of the drone 30a that are obtained by the smartphone 10a and the global positional coordinates DA and DB that are obtained by the drone 30a, the global positional coordinates obtained by the apparatus exhibiting a higher GPS performance are more reliable and given priority.

Thus, when a GPS signal is currently successfully received by the drone 30a, the final global positional coordinates CO of the drone 30a that are to be adopted are obtained using the following formula: CO=w3×DA+w4×SC. w3>w4 when the drone 30a exhibits a higher GPS performance, and w3<w4 when the smartphone 10a exhibits a higher GPS performance.

Further, when the drone 30a successfully received a GPS signal in the past but currently fails to receive the GPS signal, the final global positional coordinates CO of the drone 30a that are to be adopted are obtained using the following formula: CO=w5×DB+w6×SC. w5>w6 when the drone 30a exhibits a higher GPS performance, and w5<w6 when the smartphone 10a exhibits a higher GPS performance.

### (3) SLAM Performance (Performance to Measure Relative Change in Position) of Each of Smartphone 10a and Drone 30a

With respect to the global positional coordinates SC (in the case of “=SB+ΔSC”) of the drone 30a that are obtained by the smartphone 10a and the global positional coordinates DB that are obtained by the drone 30a, the global positional coordinates obtained by the apparatus exhibiting a higher SLAM performance are more reliable and given priority.

Thus, the final global positional coordinates CO of the drone 30a that are to be adopted are obtained using the following formula: CO=w7×DB+w8×SC. w7>w8 when the drone 30a exhibits a higher SLAM performance, and w7<w8 when the smartphone 10a exhibits a higher SLAM performance.

### (4) Relative Distance Between Smartphone 10a and Drone 30a

With respect to the global positional coordinates SC of the drone 30a that are obtained by the smartphone 10a, the global positional coordinates obtained when a relative distance ΔSC between the smartphone 10a and the drone 30a is smaller, are more reliable and given priority.

Thus, with respect to the above-described weight values w2, w4, w6, and w8, the weight is larger if the relative distance ΔSC between the smartphone 10a and the drone 30a is smaller, and the weight is smaller if the relative distance ΔSC is larger.

### (5) Performance to Measure Relative Position of Smartphone 10a Relative to Drone 30a

With respect to the global positional coordinates SC of the drone 30a that are obtained by the smartphone 10a, the global positional coordinates obtained when the smartphone 10a exhibits a higher performance to measure the relative position, are more reliable and given priority. For example, the smartphone 10a including the depth sensor 17 exhibiting a higher performance, exhibits a higher measurement performance, and the smartphone 10a including the depth sensor 17 exhibiting a lower performance, exhibits a lower measurement performance.

In this case, with respect to the above-described weight values w2, w4, w6, and w8, the weight is larger if the smartphone 10a exhibits a higher performance to measure the relative position, and the weight is smaller if the smartphone 10a exhibits a lower performance to measure the relative position.

### (6) Others

Here, there is a possibility that a GPS signal will never be successfully received by the drone 30a itself and thus DA and DB, which are described above, will not be successfully obtained. In such a case, the drone 30a can also start flying by receiving initial position data (the global positional coordinates SC obtained for the first time) from the smartphone 10a (Step 204). Further, thereafter, position data obtained for the second and subsequent times (the global positional coordinates SC obtained for the second and subsequent times) may be received from the smartphone 10a (refer to Step 209).

In this case, the controller 31 of the drone 30a calculates the global positional coordinates CO of the drone 30a using the following formula: CO=ΔDB+SC (ΔDB: the relative movement position of the drone 30a that are obtained by SLAM processing being performed by the drone 30a). Here, a weight value based on a degree of reliability may be used. In this case, CO=w9×ΔDB+w10×SC. ΔDB of the drone 30a is only difference information, whereas SC of the smartphone 10a corresponds to a value in the global coordinate system. Thus, SC is more reliable than AB and given priority over ΔB. Thus, typically, w9<w10 in this case.

Note that a portion of, or all of the weighting performed on the basis of a degree of reliability in (1) to (6) described above, may be performed.

### Operations and Others

As described above, in the first embodiment, the smartphone 10a calculates global positional coordinates of the smartphone 10a, observes the drone 30a to calculate a relative position of the smartphone 10a relative to the drone 30a, and calculates global positional coordinates of the smartphone 10a on the basis of the global positional coordinates of the smartphone 10a and the relative position.

Thus, in the first embodiment, the drone 30a can acquire global positional coordinates of the drone 30a even when, for example, the drone 30a fails to obtain the global positional coordinates by itself due to the drone 30a being situated, for example, indoors. Accordingly, the drone 30a can start flying or can fly while being aware of global positional coordinates of the drone 30a even when the drone 30a fails to obtain the global positional coordinates by itself.

Further, in the first embodiment, even when the smartphone 10a fails to acquire a GPS signal after the smartphone 10a once acquires the GPS signal and once acquires global positional coordinates of the smartphone 10a, the smartphone 10a calculates the global positional coordinates of the smartphone 10a by performing SLAM processing.

Thus, in the first embodiment, the smartphone 10a can estimate a self-position in the global coordinate system even when the smartphone 10a is moved from a place where a GPC signal is received to a place where the GPS signal is not received. Thus, the smartphone 10a can obtain global positional coordinates of the drone 30a by observing the drone 30a even when the smartphone 10a is moved to a place where a GPS signal is not received. Then, the smartphone 10a can notify the drone 30a of the obtained global positional coordinates of the drone 30a.

Furthermore, in the first embodiment, the drone 30a calculates final global positional coordinates of the drone 30a on the basis of global positional coordinates (the first global positional coordinates) received from the smartphone 10a and global positional coordinates (the second global positional coordinates) obtained by the drone 30a itself.

This makes it possible to increase a degree of precision of final global positional coordinates of the drone 30a.

Further, in the first embodiment, the drone 30a calculates final global positional coordinates of the drone 30a on the basis of specified degrees of reliability of global positional coordinates (the first global positional coordinates) received from the smartphone 10a and global positional coordinates (the second global positional coordinates) obtained by the drone 30a itself.

This makes it possible to further increase a degree of precision of final global positional coordinates of the drone 30a.

Furthermore, in the first embodiment, the specified degree of reliability is related to at least one of the stability in a GPS signal received by the drone 30a, s GPS performance of each of the smartphone 10a and the drone 30a, a performance of each of the smartphone 10a and the drone 30a to measure a relative change in a position of a corresponding one of the smartphone 10a and the drone 30a (a SLAM performance), a relative distance between the smartphone 10a and the drone 30a, or a performance of the smartphone 10a to measure the relative position.

This makes it possible to further increase a degree of precision of final global positional coordinates of the drone 30a.

### Second Embodiment

Next, a second embodiment of the present technology is described. In the description of and after the second embodiment, a portion that has a configuration and a function respectively similar to a configuration and a function of a portion described in the first embodiment above is denoted by a reference numeral similar to the portion described in the first embodiment above, and a description thereof is omitted or simplified.

The example in which the drone 30a includes the SLAM function has been described in the first embodiment above. On the other hand, a drone 30b does not include the SLAM function in the second embodiment. Thus, the processing performed by the smartphone 10a and the processing performed by the drone 30b are slightly different from those in the first embodiment.

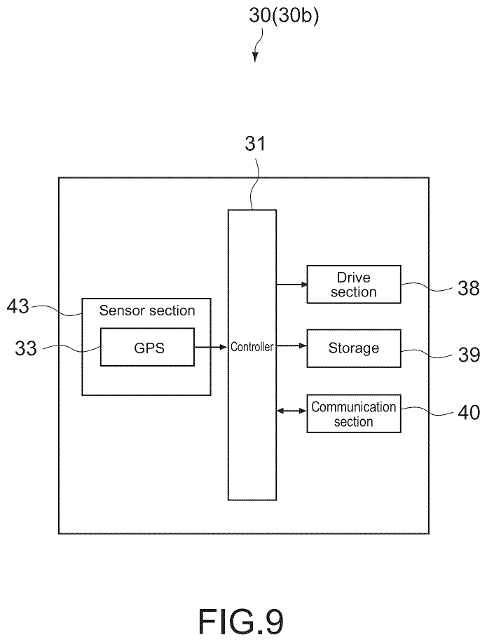

FIG. 9 is a block diagram illustrating an internal configuration of the drone 30b according to the second embodiment. In the second embodiment, the drone 30b includes the GPS 33 as a sensor section 43, but does not include, for example, the IMU 34 and depth sensor 37 being used for the SLAM function, as illustrated in FIG. 9.

### Description of Operation

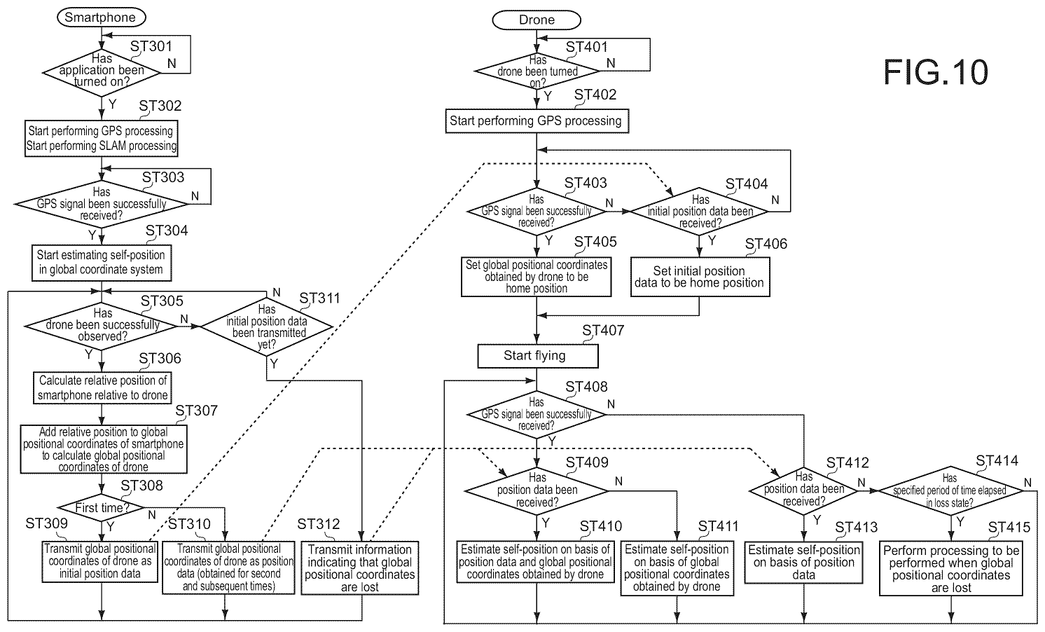

FIG. 10 is a flowchart of processing performed by the smartphone 10a according to the second embodiment and processing performed by the drone 30b according to the second embodiment.

[Processing Performed by Smartphone 10a]

In the second embodiment, the controller 11 of the smartphone 10a performs the processes of Steps 301 to 312 illustrated in FIG. 10. The processes of Steps 301 to 310 are similar to the processes of Steps 101 to 110 illustrated in FIG. 5. On the other hand, FIG. 10 is different from FIG. 5 in that the processes of Steps 311 and 312 are added.

The controller 11 of the smartphone 10a receives a GPS signal (YES in Step 303), and starts performing processing of estimating a self-position in the global coordinate system (Step 304). Thereafter, the controller 11 determines whether the depth sensor 17 has observed the drone 30b (Step 305).

When it has been determined that the drone 30b has not been observed (NO in Step 305), the controller 11 of the smartphone 10a determines whether initial position data has been already transmitted (Step 311).

When it has been determined that the drone 30b has not been observed and that the initial position data has not been transmitted yet (NO in Step 311), the controller 11 of the smartphone 10a returns to Step 305, and determines again whether the depth sensor 17 has observed the drone 30b.

On the other hand, when it has been determined that the drone 30b has not been observed and that the initial position data has been already transmitted (YES in Step 311), the controller 11 of the smartphone 10a transmits, to the drone 30b, information indicating that global positional coordinates of the drone 30b are lost (Step 312).

Note that, after the initial position data is once transmitted by the smartphone 10a, one of pieces of information that are position data obtained for the second and subsequent times and information indicating that global positional coordinates of the drone 30b are lost is transmitted from the smartphone 10a to the drone 30a in a specified cycle (refer to Steps 310 and 312).

[Processing Performed by Drone 30b]

In Steps 401 to 406, the controller 31 of the drone 30b performs processing similar to the processing performed in Steps 201 to 206 illustrated in FIG. 5. The controller 31 of the drone 30b sets, to be a home position, global positional coordinates obtained by the drone 30b itself on the basis of a GPS signal, or initial position data received from the smartphone 10a (Steps 405 and 406), and then starts flying the drone 30b (Step 407).

Next, the controller 31 of the drone 30b determines whether the drone 30b has successfully received a GPS signal by itself (Step 408). When it has been determined that the GPS signal has been successfully received (YES in Step 408), the controller 31 of the drone 30b determines whether position data obtained for the second and subsequent times has been received from the smartphone 10a (Step 409).

When it has been determined that the drone 30b has successfully received the GPS signal by itself and that the position data obtained for the second and subsequent times has been received from the smartphone 10a (YES in Step 409), the controller 31 of the drone 30b moves on to Step 410. In Step 410, the controller 31 of the drone 30b estimates a self-position in the global coordinate system on the basis of the position data (the first global positional coordinates) received from the smartphone 10a, and on the basis of the global positional coordinates (the second global positional coordinates) based on the GPS processing being performed by the drone 30b.

In Step 410, the controller 31 of the drone 30b determines a degree of reliability, that is, which of global positional coordinates (the position data: the first global positional coordinates) of the drone 30b that are received from the smartphone 10a and global positional coordinates (the second global positional coordinates) of the drone 30b that are obtained by the drone 30b on the basis of the GPS processing performed by the drone 30b, are reliable to what extent, as in the case of Step 210 illustrated in FIG. 5. Then, the controller 31 of the drone 30b weights the two sets of the global positional coordinates using the degrees of reliability to calculate final global positional coordinates of the drone 30b.

A basic idea regarding the weighting based on a degree of reliability is similar to that in 1. to 5, and (1) to (6) described above. However, in the second embodiment, there is no DB (global positional coordinates of the drone 30b that are obtained by the drone 30b performing SLAM processing) in 5. described above since the drone 30b does not include the SLAM function. Further, in the second embodiment, weighting is not performed on the basis of the superiority and inferiority of SLAM performances of the smartphone 10a and the drone 30b in (3) described above, since the drone 30b does not include the SLAM function.

Referring to Step 409, the controller 31 of the drone 30b moves on to Step 411 when it has been determined that the drone 30b has successfully received a GPS signal by itself and that position data obtained for the second and subsequent times has not been received from the smartphone 10a (YES in Step 409). Note that, when it has been determined that the position data obtained for the second and subsequent times has not been received, information indicating that global positional coordinates of the drone 30b are lost are received from the smartphone 10a, instead of the position data. In Step 411, the controller 31 of the drone 30b performs processing of estimating a self-position using global positional coordinates based on GPS processing performed by the drone 30b.

When it has been determined, in Step 408, that the drone 30b has not successfully received the GPS signal by itself (NO in Step 408), the controller 31 of the drone 30b determines whether position data obtained for the second and subsequent times has been received from the smartphone 10a (Step 412).

When it has been determined that the drone 30b has not successfully received the GPS signal by itself and that the position data obtained for the second and subsequent times has been received from the smartphone 10a (YES in Step 412), the controller 31 of the drone 30b sets, to be global positional coordinates of the drone 30b, the position data received from the smartphone 10a (Step 413).

When it has been determined that the drone 30b has not successfully received the GPS signal by itself and that the position data obtained for the second and subsequent times has not been received from the smartphone 10a (NO in Step 412), the controller 31 of the drone 30b moves on to Step 414.

In Step 414, the controller 31 of the drone 30b determines whether a specified period of time has elapsed in a loss state since the drone 30b entered the loss state, the loss state being a state in which the drone 30b fails to obtain global positional coordinates by itself on the basis of GPS processing performed by the drone 30b and global positional coordinates (position data) are also not received from the smartphone 10a. When the specified period of time has not elapsed in the loss state since the drone 30b entered the loss state (NO in Step 414), the controller 31 of the drone 30b returns to Step 408.

On the other hand, when the specified period of time has elapsed in the loss state since the drone 30b entered the loss state (YES in Step 414), the controller 31 of the drone 30b performs processing that is to be performed when global positional coordinates are lost (Step 415). Examples of the processing to be performed when global positional coordinates are lost include processing of causing the drone 30b to hover on the moment, processing of landing the drone 30b, processing of returning the drone 30b to the home position, and processing of returning the drone 30b to a position at which the drone 30b is situated just before entering the loss state.

### Operations and Others

In principle, the second embodiment provides an operation and an effect that are similar to those provided by the first embodiment. Note that, in the second embodiment, the drone 30b can fly properly without the drone 30b including the SLAM function. Further, in the second embodiment, the drone 30b does not necessarily have to include the SLAM function, and this makes it possible to make the drone 30b lighter in weight, and to reduce power consumption.

Here, the first embodiment described above is different from the second embodiment in that the drone 30b includes the SLAM function. Thus, if the drone 30b once successfully receives position data from the smartphone 10a, the drone 30b can estimate thereafter, only using SLAM processing, a self-position in the global coordinate system even in a state in which the drone 30b fails to receive a GPS signal by itself and to receive subsequent position data.

Thus, it is sufficient if, in the first embodiment, a user once causes the depth sensor 17 of the smartphone 10a to observe the drone 30b and once causes position data to be transmitted from the smartphone 10a to the drone 30b. In other words, after the position data is transmitted, the user does not have to turn the depth sensor 17 of the smartphone 10a to the drone 30b following flight of the drone 30b to continuously cause subsequent position data to be transmitted from the smartphone 10a to the drone 30b.

On the other hand, in the second embodiment, the drone 30b does not include the SLAM function. Thus, when the drone 30b flies about a location where the drone 30b fails to receive a GPS signal, a user typically has to turn the depth sensor 17 of the smartphone 10a to the drone 30b following flight of the drone 30b to continuously cause position data to be transmitted from the smartphone 10a to the drone 30b.

Further, in the first embodiment, it is sufficient if position data is transmitted from the smartphone 10a to the drone 30b at least once. Thus, an effective distance with which the smartphone 10a can measure a relative position of the smartphone 10a relative to the drone 30b using the depth sensor 17 may be small.

On the other hand, in the second embodiment, position data has to be continuously transmitted from the smartphone 10a to the drone 30b. Thus, a larger effective distance used to measure the relative position using the depth sensor 17 is more advantageous.

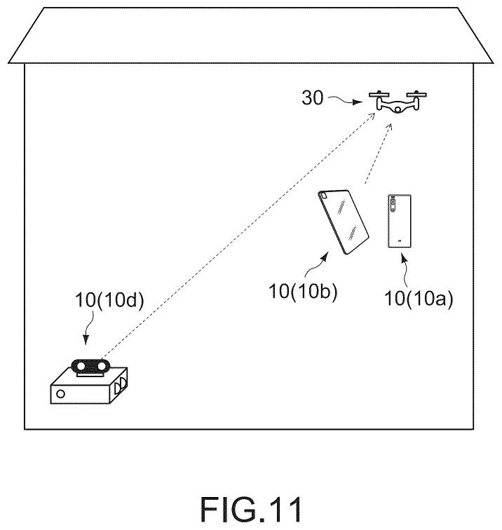

FIG. 11 illustrates effective distances used to measure a relative position using the depth sensor 17 for different kinds of the position measurement apparatus 10.

As illustrated in FIG. 11, when the position measurement apparatus 10 is the smartphone 10a or the tablet PC 10b, the effective distance used to measure a relative position using the depth sensor 17 is typically about several meters at this point. On the other hand, when the dedicated device 10d is used as the position measurement apparatus 10, the effective distance used to measure a relative position using the depth sensor 17 can also be set to several tens of meters to several hundreds of meters.

In other words, when the drone 30b does not include the SLAM function and position data has to be continuously transmitted from the position measurement apparatus 10 to the drone 30b, as in the second embodiment, using, as the measurement apparatus 10, an apparatus such as the dedicated device 10d having a large effective distance is effective in particular.

### Third Embodiment

The example in which a single position measurement apparatus 10 is used has been described in the first and second embodiments. On the other hand, an example in which a plurality of position measurement apparatuses 10 is used is described in a third embodiment.

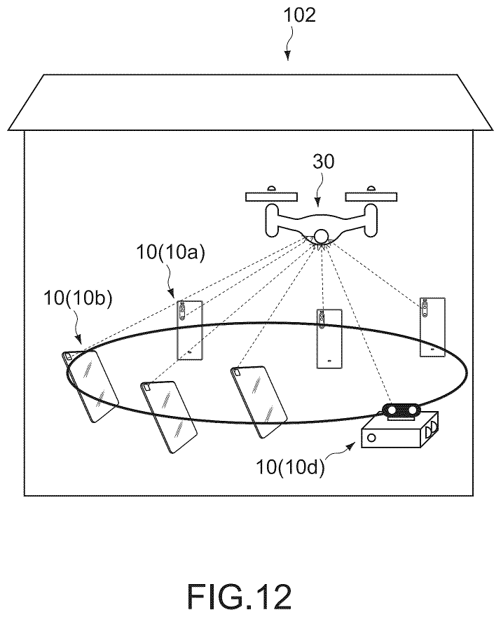

FIG. 12 illustrates a position measurement system 102 according to the third embodiment. As illustrated in FIG. 12, the position measurement system 102 according to the third embodiment includes a plurality of position measurement apparatuses 10 and a drone 30. FIG. 12 illustrates an example in which three smartphones 10a, three tablet PCs 10b, and a single dedicated device 10d are used as the position measurement apparatuses 10.

In the third embodiment, the drone 30 may include the SLAM function, or does not necessarily have to include the SLAM function.

Typically, processing performed by each position measurement apparatus 10 is similar to the processing illustrated in each of FIGS. 5 and 10. In other words, each position measurement apparatus 10 calculates global positional coordinates of the position measurement apparatus 10, and observes the drone 30 to calculate a relative position of the position measurement apparatus 10 relative to the drone 30. Then, the position measurement apparatus 10 adds the relative position to the global positional coordinates of the position measurement apparatus 10 to calculate global positional coordinates (position data) of the drone 30, and transmits the calculated global positional coordinates of the drone 30 to the drone 30.

The drone 30 integrates sets of the global positional coordinates (sets of the pieces of position data) of the drone 30 that are transmitted by the respective position measurement apparatuses 10 to calculate final global positional coordinates of the drone 30 (when the drone 30 successfully estimates a self-position by itself, the self-position will also be integrated).

When the sets of the global positional coordinates (the pieces of position data) of the drone 30 that are transmitted by the respective position measurement apparatuses 10 are integrated, weighting is performed on the basis of specified degrees of reliability.

Typically, the drone 30 determines a degree of reliability, that is, which set of the global positional coordinates of the drone 30 that is transmitted by the respective position measurement apparatuses 10 is reliable to what extent. Then, the controller 31 of the drone 30 weights each set of the global positional coordinates on the basis of the degree of reliability to calculate final global positional coordinates of the drone 30.

Note that sets of the global positional coordinates of the drone 30 that are obtained by the respective position measurement apparatuses 10 may be integrated (weighted) by one of a plurality of position measurement apparatuses 10 (for example, the dedicated device 10d), not by the drone 30.

### “Weighting Based on Degree of Reliability”

### (A) GPS Performance of Each Position Measurement Apparatus 10

With respect to global positional coordinates SC of the drone 30 that are obtained by each position measurement apparatus 10, the global positional coordinates SC obtained by the position measurement apparatus 10 exhibiting a higher GPS performance are more reliable and given priority.

### (B) SLAM Performance (Performance to Measure Relative Change in Position) of Each Position Measurement Apparatus 10

With respect to the global positional coordinates SC (in the case of “=SB+ΔSC”) of the drone 30 that are obtained by each position measurement apparatus 10, the global positional coordinates obtained by the position measurement apparatus 10 exhibiting a higher SLAM performance are more reliable and given priority.

### (C) Relative Distance Between Each Position Measurement Apparatus 10 and Drone 30

With respect to the global positional coordinates SC of the drone 30 that are obtained by each position measurement apparatus 10, the global positional coordinates obtained by the position measurement apparatus 10 from which the relative distance ΔSC to the drone 30a is smaller, are more reliable and given priority.

### (D) Performance to Measure Relative Position of Position Measurement Apparatus 10 Relative to Drone 30

With respect to the global positional coordinates SC of the drone 30 that are obtained by each position measurement apparatus 10, the global positional coordinates obtained by the position measurement apparatus 10 exhibiting a higher performance to measure a relative position ΔSC, are more reliable and given priority.

Note that a portion of, or all of the weighting performed on the basis of a degree of reliability in (A) to (D) described above, may be performed.

In the third embodiment, global positional coordinates of the drone 30 can be obtained using a plurality of position measurement apparatuses 10. This results in increasing a degree of precision of global positional coordinates of the drone 30.

Further, when the drone 30 does not include the SLAM function, there are advantages in observing the drone 30 using a plurality of position measurement apparatuses 10, as in the third embodiment. In other words, when the drone 30 does not include the SLAM function and the drone 30 fails to receive a GPS signal, position data has to be continuously transmitted from the position measurement apparatus 10 to the drone 30. On the other hand, a plurality of position measurement apparatuses 10 is used in the third embodiment. Thus, even if a portion of the plurality of position measurement apparatuses 10 fail to observe the drone 10, another portion of the plurality of position measurement apparatuses 10 will observe the drone 30, and can transmit position data to the drone 30.

### Fourth Embodiment

Next, a fourth embodiment of the present technology is described. An example in which global positional coordinates of the drone 30 are obtained by a plurality of position measurement apparatuses 10 in a relay manner, is described in the fourth embodiment.

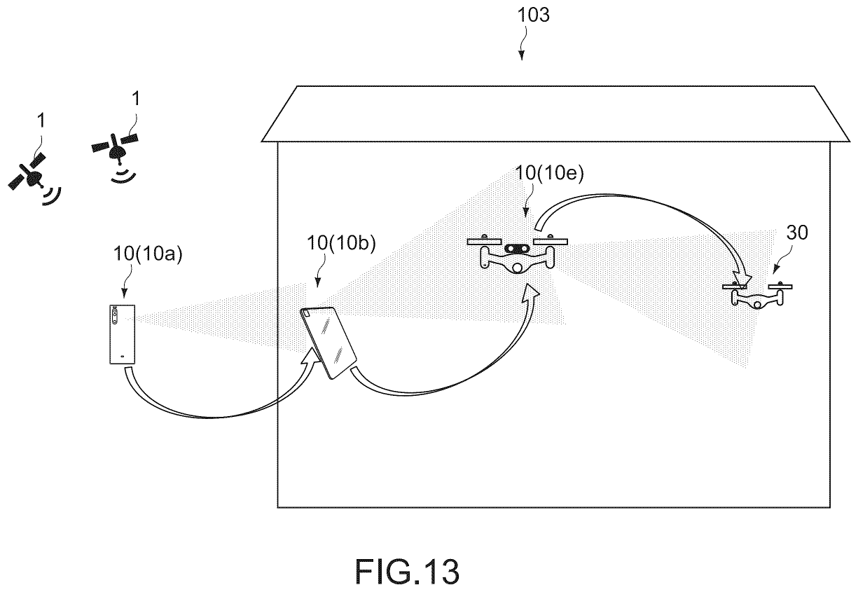

FIG. 13 illustrates a position observation system 103 according to the fourth embodiment of the present technology. As illustrated in FIG. 13, the position measurement system according to the fourth embodiment includes the smartphone 10a, the tablet PC 10b, a first drone 10e, and a second drone 30, where the smartphone 10a, the tablet PC 10b, and the first drone 10e serve as the position measurement apparatuses 10, and the second drone 30 serves as the target 30.

The second drone 30 may include the SLAM function, or does not necessarily have to include the SLAM function.

In the fourth embodiment, a certain position measurement apparatus 10 of a plurality of position measurement apparatuses 10 performs measurement on another position measurement apparatus 10 of the plurality of position measurement apparatuses 10, and calculates a relative position of the certain position measurement apparatus 10 relative to the other position measurement apparatus 10. Then, the certain position measurement apparatus 10 calculates global positional coordinates of the other position measurement apparatus 10 on the basis of global positional coordinates of the certain position measurement apparatus 10 and the relative position, and transmits the calculated global positional coordinates of the other position measurement apparatus 10 to the other position measurement apparatus 10.

Further, in the fourth embodiment, the other position measurement apparatus 10, which is an observation target and can observe the target 30, observes the target 30 to calculate a relative position of the other position measurement apparatus 10 relative to the target 30, and calculates global positional coordinates of the target 30 on the basis of global positional coordinates of the other position measurement apparatus 10 and the relative position.

A specific description is made with reference to FIG. 13. In the example illustrated in FIG. 13, the smartphone 10a successfully receives a GPS signal, whereas the tablet PC 10b, the first drone 10e, and the second drone 30 fail to receive a GPS signal.

The smartphone 10a calculates global positional coordinates of the smartphone 10a by performing GPS processing and SLAM processing. Then, using the depth sensor 17, the smartphone 10a observes the tablet PC 10b to calculate a relative position of the smartphone 10a relative to the tablet PC 10b. Thereafter, the smartphone 10a adds the relative position to the global positional coordinates of the smartphone 10a to calculate global positional coordinates of the tablet PC 10b, and transmits the calculated global positional coordinates of the tablet PC 10b to the tablet PC 10b.

The tablet PC 10b calculates global positional coordinates of the tablet PC 10b using the global positional coordinates of the tablet PC 10b that are received from the smartphone 10a and by performing SLAM processing. Then, using the depth sensor 17, the tablet PC 10b observes the first drone 10e to calculate a relative position of the tablet PC 10b relative to the first drone 10e. Thereafter, the tablet PC 10b adds the relative position to the global positional coordinates of the tablet PC 10b to calculate global positional coordinates of the first drone 10e, and transmits the calculated global positional coordinates of the first drone 10e to the first drone 10e.

The first drone 10e calculates global positional coordinates of the first drone 10e using the global positional coordinates of the first drone 10e that are received from the tablet PC 10b, and by performing SLAM processing. Then, using the depth sensor 17, the first drone 10e observes the second drone 30 to calculate a relative position of the first drone 10e relative to the second drone 30. Thereafter, the first drone 10e adds the relative position to the global positional coordinates of the first drone 10e to calculate global positional coordinates of the second drone 30, and transmits the calculated global positional coordinates of the second drone 30 to the second drone 30.

The fourth embodiment makes it possible to deal with a large distance even when an effective distance with which the depth sensor 17 of each position measurement apparatus 10 can measure a relative position is small.

### Others

The present technology may also take the following configurations.

(1) An information processing method, including:
calculating, by a position measurement apparatus, global positional coordinates of the position measurement apparatus;
observing, by the position measurement apparatus, a target to calculate a relative position of the position measurement apparatus relative to the target; and
calculating, by the position measurement apparatus, first global positional coordinates of the target on the basis of the global positional coordinates of the position measurement apparatus and the relative position.
   (2) The information processing method according to (1), in which
the position measurement apparatus calculates the global coordinates of the position measurement apparatus on the basis of a GPS signal received by the position measurement apparatus.
   (3) The information processing method according to (2), in which
the position measurement apparatus calculates the global positional coordinates of the position measurement apparatus on the basis of the GPS signal and on the basis of a relative change in a position of the position measurement apparatus.
   (4) The information processing method according to (3), in which
when the GPS signal fails to be acquired after the GPS signal is once acquired, the position measurement apparatus calculates the global positional coordinates of the position measurement apparatus on the basis of the relative change in the position.
   (5) The information processing method according to (3) or (4), in which
the position measurement apparatus transmits the first global positional coordinates of the target to the target.
   (6) The information processing method according to (5), in which
the target sets global positional coordinates of the target on the basis of the first global positional coordinates of the target that are transmitted by the position measurement apparatus.
   (7) The information processing method according to (6), in which
the target calculates second global positional coordinates of the target on the basis of a GPS signal received by the target.
   (8) The information processing method according to (7), in which
the target calculates the global positional coordinates of the target on the basis of the first global positional coordinates and on the basis of the second global positional coordinates.
   (9) The information processing method according to (8), in which
the target calculates the global positional coordinates of the target by weighting the first global positional coordinates and the second global positional coordinates on the basis of the specified degrees of reliability.
   (10) The information processing method according to (9), in which
the specified degree of reliability is related to at least one of stability in the GPS signal received by the target, a GPS performance of each of the position measurement apparatus and the target, a relative distance between the position measurement apparatus and the target, or a performance of the position measurement apparatus to measure the relative position.
   (11) The information processing method according to (9) or (10), in which
the target calculates the second global positional coordinates of the target on the basis of the GPS signal and on the basis of a relative change in a position of the target, and
the specified degree of reliability is related to a performance of the position measurement apparatus to measure the relative change in the position of the position measurement apparatus and a performance of the target to measure the relative change in the position of the target.
   (12) The information processing method according to any one of (3) to (11), in which
a plurality of the position measurement apparatuses is included, and
each of the plurality of the position measurement apparatuses
   calculates global positional coordinates of the position measurement apparatus,
   observes the target to calculate a relative position of the position measurement apparatus relative to the target, and
   calculates the first global positional coordinates of the target on the basis of the global positional coordinates of the position measurement apparatus and on the basis of the relative position.
      (13) The information processing method according to (12), in which
the target or the position measurement apparatus calculates global positional coordinates of the target on the basis of the first global positional coordinates calculated by each of the plurality of position measurement apparatuses.
   (14) The information processing method according to (13), in which
the target or the position measurement apparatus calculates the global positional coordinates of the target by weighting the first global positional coordinates calculated by each of the plurality of position measurement apparatuses on the basis of a corresponding one of specified degrees of reliability.
   (15) The information processing method according to (14), in which
the specified degree of reliability is related to at least one of a GPS performance of each of the plurality of position measurement apparatuses, a performance of each of the plurality of position measurement apparatuses to measure a relative change in a position of the position measurement apparatus, a relative distance between each of the plurality of position measurement apparatuses and the target, or a performance of each of the plurality of position measurement apparatuses to measure the relative position.
   (16) The information processing method according to any one of (1) to (15), in which
a plurality of the position measurement apparatuses is included, and
a certain position measurement apparatus of the plurality of the position measurement apparatuses
   performs measurement on another position measurement apparatus of the plurality of position measurement apparatuses,
   calculates a relative position of the certain position measurement apparatus relative to the other position measurement apparatus, and
   calculates global positional coordinates of the other position measurement apparatus on the basis of global positional coordinates of the certain position measurement apparatus and the relative position.
      (17) The information processing method according to (16), in which
the other position measurement apparatus, which is an observation target and by which the target is observable,
   observes the target to calculate a relative position of the other position measurement apparatus relative to the target, and
   calculates the first global positional coordinates of the target on the basis of the global positional coordinates of the other position measurement apparatus and the relative position.
      (18) A program that causes a position measurement apparatus to perform a process including:
calculating global positional coordinates of the position measurement apparatus;
observing a target to calculate a relative position of the position measurement apparatus relative to the target; and
calculating first global positional coordinates of the target on the basis of the global positional coordinates of the position measurement apparatus and the relative position.
   (19) A position measurement apparatus, including
a controller that
   calculates global positional coordinates of the position measurement apparatus,
   observes a target to calculate a relative position of the position measurement apparatus relative to the target, and
   calculates first global positional coordinates of the target on the basis of the global positional coordinates of the position measurement apparatus and the relative position.
      (20) A position measurement system, including:
a position measurement apparatus; and
a target,
the position measurement apparatus including a controller that calculates global positional coordinates of the position measurement apparatus, observes the target to calculate a relative position of the position measurement apparatus relative to the target, and calculates first global positional coordinates of the target on the basis of the global positional coordinates of the position measurement apparatus and the relative position.

### REFERENCE SIGNS LIST

1 GPS satellite
10 position measurement apparatus
10a smartphone
11 controller
30 target
30a, 30b drone
31 controller
100 to 103 position measurement system

1. An information processing method, comprising:
calculating, by a position measurement apparatus, global positional coordinates of the position measurement apparatus;
observing, by the position measurement apparatus, a target to calculate a relative position of the position measurement apparatus relative to the target; and
calculating, by the position measurement apparatus, first global positional coordinates of the target on a basis of the global positional coordinates of the position measurement apparatus and the relative position.

2. The information processing method according to claim 1, wherein
the position measurement apparatus calculates the global coordinates of the position measurement apparatus on a basis of a GPS signal received by the position measurement apparatus.

3. The information processing method according to claim 2, wherein
the position measurement apparatus calculates the global positional coordinates of the position measurement apparatus on the basis of the GPS signal and on a basis of a relative change in a position of the position measurement apparatus.

4. The information processing method according to claim 3, wherein
when the GPS signal fails to be acquired after the GPS signal is once acquired, the position measurement apparatus calculates the global positional coordinates of the position measurement apparatus on the basis of the relative change in the position.

5. The information processing method according to claim 3, wherein
the position measurement apparatus transmits the first global positional coordinates of the target to the target.

6. The information processing method according to claim 5, wherein
the target sets global positional coordinates of the target on a basis of the first global positional coordinates of the target that are transmitted by the position measurement apparatus.

7. The information processing method according to claim 6, wherein
the target calculates second global positional coordinates of the target on a basis of a GPS signal received by the target.

8. The information processing method according to claim 7, wherein
the target calculates the global positional coordinates of the target on the basis of the first global positional coordinates and on a basis of the second global positional coordinates.

9. The information processing method according to claim 8, wherein
the target calculates the global positional coordinates of the target by weighting the first global positional coordinates and the second global positional coordinates on a basis of the specified degrees of reliability.

10. The information processing method according to claim 9, wherein
the specified degree of reliability is related to at least one of stability in the GPS signal received by the target, a GPS performance of each of the position measurement apparatus and the target, a relative distance between the position measurement apparatus and the target, or a performance of the position measurement apparatus to measure the relative position.

11. The information processing method according to claim 9, wherein
the target calculates the second global positional coordinates of the target on the basis of the GPS signal and on a basis of a relative change in a position of the target, and
the specified degree of reliability is related to a performance of the position measurement apparatus to measure the relative change in the position of the position measurement apparatus and a performance of the target to measure the relative change in the position of the target.

12. The information processing method according to claim 3, wherein
a plurality of the position measurement apparatuses is included, and
each of the plurality of the position measurement apparatuses
calculates global positional coordinates of the position measurement apparatus,
observes the target to calculate a relative position of the position measurement apparatus relative to the target, and
calculates the first global positional coordinates of the target on a basis of the global positional coordinates of the position measurement apparatus and on a basis of the relative position.

13. The information processing method according to claim 12, wherein
the target or the position measurement apparatus calculates global positional coordinates of the target on a basis of the first global positional coordinates calculated by each of the plurality of position measurement apparatuses.

14. The information processing method according to claim 13, wherein
the target or the position measurement apparatus calculates the global positional coordinates of the target by weighting the first global positional coordinates calculated by each of the plurality of position measurement apparatuses on a basis of a corresponding one of specified degrees of reliability.

15. The information processing method according to claim 14, wherein
the specified degree of reliability is related to at least one of a GPS performance of each of the plurality of position measurement apparatuses, a performance of each of the plurality of position measurement apparatuses to measure a relative change in a position of the position measurement apparatus, a relative distance between each of the plurality of position measurement apparatuses and the target, or a performance of each of the plurality of position measurement apparatuses to measure the relative position.

16. The information processing method according to claim 1, wherein
a plurality of the position measurement apparatuses is included, and
a certain position measurement apparatus of the plurality of the position measurement apparatuses
performs measurement on another position measurement apparatus of the plurality of position measurement apparatuses,
calculates a relative position of the certain position measurement apparatus relative to the other position measurement apparatus, and
calculates global positional coordinates of the other position measurement apparatus on a basis of global positional coordinates of the certain position measurement apparatus and the relative position.

17. The information processing method according to claim 16, wherein
the other position measurement apparatus, which is an observation target and by which the target is observable,
observes the target to calculate a relative position of the other position measurement apparatus relative to the target, and
calculates the first global positional coordinates of the target on a basis of the global positional coordinates of the other position measurement apparatus and the relative position.

18. A program that causes a position measurement apparatus to perform a process comprising:
calculating global positional coordinates of the position measurement apparatus;
observing a target to calculate a relative position of the position measurement apparatus relative to the target; and
calculating first global positional coordinates of the target on a basis of the global positional coordinates of the position measurement apparatus and the relative position.

19. A position measurement apparatus, comprising
a controller that
calculates global positional coordinates of the position measurement apparatus,
observes a target to calculate a relative position of the position measurement apparatus relative to the target, and
calculates first global positional coordinates of the target on a basis of the global positional coordinates of the position measurement apparatus and the relative position.

20. A position measurement system, comprising:
a position measurement apparatus; and
a target,
the position measurement apparatus including a controller that calculates global positional coordinates of the position measurement apparatus, observes the target to calculate a relative position of the position measurement apparatus relative to the target, and calculates first global positional coordinates of the target on a basis of the global positional coordinates of the position measurement apparatus and the relative position.
